(19) United States
(12) Patent Application Publication
(10) Pub. No.: US 2011/0004516 A1
(43) Pub. Date: Jan. 6, 2011

(54) INTERNET MARKETPLACE FOR VENDORS AND CONSUMERS WITH CENTRALIZED INCENTIVE DISTRIBUTION

(76) Inventor: Adi Oved, Flushing, NY (US)

Correspondence Address: OSTROLENK FABER GERB & SOFFEN, 1180 AVENUE OF THE AMERICAS, NEW YORK, NY, 100368403, US

(21) Appl. No.: 12/498,105

(22) Filed: Jul. 6, 2009

(51) Int. Cl. G06Q 30/00

(52) U.S. Cl. 705/14.39

(57) ABSTRACT

An electronic commerce center is provided that includes at least one processor operatively coupled to one or more processor readable media and a communication port. A database that is accessible by the at least one processor and stored on the at least one or more processor readable media is provided. The database comprises electronic vendor information that represents vendors of one or more of goods and services. The database further comprises electronic goods and services information that represents at least one of goods and services offered for sale by the vendors. The database further comprises electronic consumer information that represents consumers of goods and services. An Internet web site provided by the at least one processor includes electronic tools for the vendors to build custom web pages to be included in the Internet web site. The web site further includes interactive options for the consumers to communicate with each other. The processor uses the electronic goods and services information to generate electronic incentive information that represents incentives offered by the vendors, and the incentives relate to the at least one of goods and services offered for sale by the vendors.

### BACKGROUND OF THE INVENTION

The present invention generally relates to Internet-based commerce, of the type providing purchase incentives such as coupons, reduced price sales and the like. More specifically, the present invention relates to an Internet-based marketplace, which provides an extensive suite of services to vendors and consumers, designed to attract vendors and consumers with centralized services and a uniquely tailored distribution of purchasing incentives, such as coupons, sales information and specific goods to consumers.

The Internet forum for commerce has been gaining steadily on the so-called brick and mortar retail establishments, in national and international commerce. Internet businesses, such as the widely known Amazon network, has brought to consumers through online interactive communication, the ability to purchase goods and services of a huge variety and from geographically dispersed locations.

At the same time, the ease with which consumers can be reached or with which consumers can reach vendors on the Internet platform, has made competition between vendors of goods and services much more fierce requiring greater effort to attract and retain consumers. From other perspectives, consumers are bombarded with information and find it more difficult to select goods in the most optimal manner in view of the huge amount of sometimes confusing data and information.

To this end, to promote trade, vendors have been using for generations, including over the Internet, incentives to lure consumers through the use of certificates, such as coupons, tickets, reduced price sales, etc. The certificates typically contain data, which describe the particular goods or transaction, including a coupon amount and an expiration date. The certificates typically contain data encoded in various numbers, letters, barcodes or other examples which seek to identify the particular coupon certificate, where it was distributed, its expiration date and the like.

Prior art couponing techniques have had several disadvantages, including low response rates and fraud. In the prior art, coupons are typically distributed using direct mailing techniques, printed in newspapers, magazines or the like or distributed with other commercial goods. Such techniques require massive amounts of printing and distribution, and historically have produced below par results. In part, this may be due to the difficulty consumers have in maintaining, cataloging and finding appropriate coupons before they set out to shop for various goods and services.

From the perspective of fraud, modern desktop publishing has made it possible for relatively unsophisticated consumers to duplicate or alter coupons, to the detriment of vendors.

By its very nature, Internet advertising has a global reach. Vendors aim to reach consumers and buyers, no matter where they are located. Large and financially powerful businesses have a significant advantage over small businesses by establishing, advertising and gaining traction to their web sites. Others, whose products are in great demand, have no difficulty advertising their wares and services through web sites of others, often through third-party search engines and vendors such as Amazon, which hosts products of third-party vendors.

However, there is a long felt, but unmet need for an Internet commerce center, which is more accessible to local businesses and which is instrumental to provide various tools for vending businesses which assist in setting up their web sites and gain access to local, international, as well as remote consumers, and also easily providing advertisement and incentives in the form of coupons and the like, particularly to geographically local consumers.

### SUMMARY OF THE INVENTION

Accordingly, it is an object of the present invention to provide an Internet commerce center, which avoids the aforementioned and other drawbacks of the prior art.

In particular, the present invention provides a new and convenient way for vendors to draw customers into their stores, to increase sales for vendors and to provide customers with unique savings opportunities on goods and services. The invention provides an Internet commerce center which more readily and less expensively allows businesses to establish a presence on the Internet, to produce customized advertising and distribute incentives such as coupons, for sale ads, discount advertisements, clearances and the like, without having to invest substantial sums which may be beyond the financial means of local businesses. Coupons of virtually any type and value are generated and distributed to customers. The coupons can identify customers, the price of goods, dates of an offer or any other information that applies to such coupons, to increase the use of such coupons, and to generally grow Internet commerce.

Accordingly, an electronic commerce center is provided that includes at least one processor operatively coupled to one or more processor readable media and a communication port. A database that is accessible by the at least one processor and stored on the at least one or more processor readable media is provided. The database comprises electronic vendor information that represents vendors of one or more of goods and services. The database further comprises electronic goods and services information that represents at least one of goods and services offered for sale by the vendors. The database further comprises electronic consumer information that represents consumers of goods and services. An Internet web site provided by the at least one processor includes electronic tools for the vendors to build custom web pages to be included in the Internet web site. The web site further includes interactive options for the consumers to communicate with each other. The processor uses the electronic goods and services information to generate electronic incentive information that represents incentives offered by the vendors, and the incentives relate to the at least one of goods and services offered for sale by the vendors.

Other features and advantages of the present invention will become apparent from the following description of the invention that refers to the accompanying drawings.

### BRIEF DESCRIPTION OF THE DRAWINGS

FIG. 1 illustrates an example hardware arrangement of an Internet commerce center, in accordance with an embodiment.

FIG. 2 illustrates an example layout of parties associated with an Internet commerce center in an embodiment.

FIG. 3 illustrates an example Internet web site map that represents a series of web pages and/or functionality provided in a preferred embodiment.

### DETAILED DESCRIPTION OF EMBODIMENTS OF THE INVENTION

An Internet commerce center is provided that makes local businesses more accessible to consumers, and which provides various tools for vendors to develop and launch web sites, thereby gaining access to local, international, as well as remote consumers. Further, the Internet commerce center provides an advertisement medium for incentives, preferably in the form of coupons and the like, and particularly suitable for geographically local consumers.

In a preferred embodiment, an interactive Internet web site is provided that allows businesses to establish a presence on the Internet, to issue customized advertising and to distribute incentives such as coupons, advertisements, discount advertisements, sales of clearance items and the like to consumers and users of web browser software applications. Coupons or other incentives that are distributed to consumers are preferably redeemed at a store or other location where the issuing business operates.

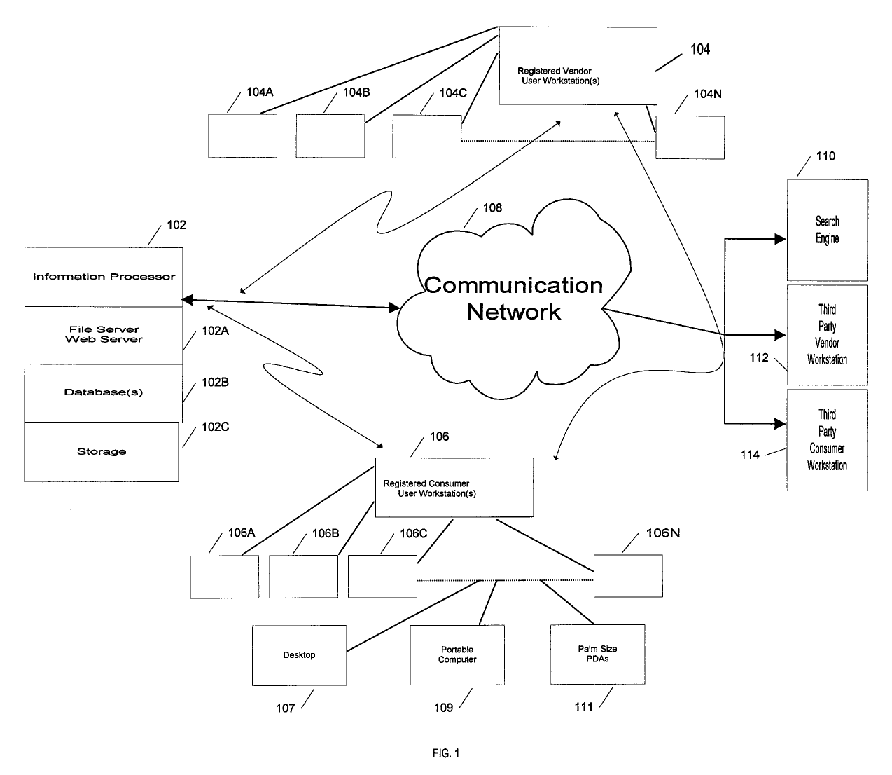

Referring now to the drawing figures, in which like reference numerals refer to like elements, FIG. 1 illustrates an example hardware arrangement, in accordance with an embodiment, and referred generally to system 100. System 100 preferably including information processor(s) 102 including a file server 100a, database 102b, vast storage 102c, etc. is configured to operate as a web, data and file server, as known to those skilled in the art. Numerous registered vendor workstations 104a, 104b . . . 104n (collectively 104) are preferably configured to send and receive information electronically from information processor 102. In a preferred embodiment, registered vendor workstations 104 are operated by or under the control of vendors of goods and/or services who have registered with information processor 102. Moreover, numerous registered consumer workstations 106 (106a, 106b . . . 106n) are preferably operated by consumers of goods and/or services who have registered with information processor 102.

Registered consumer workstations 106 are preferably configured to send to and receive information from information processor 102, as well as to send information to and receive information from registered vendor user workstations 104. Information processor 102 preferably stores information regarding registered vendors and registered consumers in the database 102b. For example, information processor 102 preferably stores information regarding coupons, sale advertisements, discounts, clearance items and information regarding registered vendors, including demographic information, as well as information regarding goods and services provided or offered for sale by registered vendors. Information processor 102 further stores information regarding registered consumers, including demographic information, socio-economic information, purchasing interests or the like. Preferably, information processor 102, registered vendor workstations 104 and registered consumer workstations 106 communicate via communication network 108. Consumers (as well as vendors) may communicate via portable communication devices such as programmable telephones 107 (IPHONE, BLACKBERRY, etc.) portable computers 109, palm size PDAs 111 and the like.

Further, and as shown in FIG. 1, other hardware devices, including devices operated or controlled by parties who are otherwise unaffiliated with information processor 102, are included. For example, search engine web site 110, third-party vendor workstations 112 and third party consumer workstations 114 are also configured to communicate over communication network 108 with one or more of information processor 102, registered vendor workstations 104 or registered consumer workstations 106.

In accordance with a preferred embodiment, a web site hosted by information processor 102 includes exclusive portions that are accessible by registered vendor workstations 104 and registered consumer workstations 106, respectively. For example, a web site hosted by information processor 102 preferably includes an administrative section of the web site for vendors to submit information regarding goods, advertisements, coupons, discounts or the like. Preferably, the registered vendor completes an initial registration procedure with a proprietor of information processor 102, such as by submitting personal and professional information, and thereafter by paying a fee. In alternative embodiments, vendors and/or consumers may register with a proprietor of information processor 102 without paying a fee. Thereafter, the registered vendor is provided with information for accessing one or more restricted web pages hosted by information processor 102, such as via secured uniform resource locator (“URL”), user name and password, that is accessible by the registered vendor for a period of time.

Thus and as used herein, the term “registered vendor” refers, generally, to a vendor of goods and/or services that has registered with a proprietor of information processor 102 for the purpose of offering goods and services for sale in accordance with the teachings herein. Vendors who are not registered are referred to herein, generally, as third party or non-registered vendors. Also as used herein, the term, “registered consumer,” refers, generally, to a consumer of goods and/or services who has registered with the proprietor of information processor 102 for the purpose of browsing and/or purchasing goods and services offered for sale in accordance with the teachings herein. Consumers who are not registered are referred to herein, generally, as third party or non-registered consumers. As used herein, the term, “module” refers, generally, to one or more discrete components that contribute to the effectiveness of the present invention. Modules can operate or, alternatively, depend upon one or more other modules in order to function.

Preferably, registered vendors pay a periodic fee, such as a monthly, quarterly, biannual or annual fee, for use of the systems and methods described herein. Alternatively, registered vendors pay use fees for use of the systems and methods described herein. For example, vendors may remunerate the proprietor of information processor 102 with a percentage of each sale made in accordance with teachings herein. For example, a registered vendor normally sells a power drill for $50.00. The registered vendor uploads information to information processor 102 for a 10% discount. A registered consumer prints a coupon for the 10% savings, and hands the coupon to the registered vendor at the time of sale, and pays $45.00 for the drill. The registered vendor gives an extra 2% ($1.00) to the proprietor of information processor 102. Payment may be tendered in any of suitable ways, such as via charging a credit card, making a PAYPAL mailing payment, or physically mailing payment (e.g., a check) to the proprietor.

In accordance with one preferred embodiment, each registered vendor of information processor 102 is assigned a URL and corresponding web site storage space on information processor 102. The registered vendor preferably uploads content to information processor 102, such as an Adobe portable document format (“PDF”) file, that includes various information regarding goods and/or services, and incentives offered by the registered vendor. Registered vendors can also upload and/or select respective language that the registered vendor wants to appear either in a web page, on a coupon, or other medium.

Information processor 102 preferably includes all databases necessary to support the systems and methods provided herein. It is contemplated, that information processor 102 can access any required database via communication network 108, to which information processor 102 may be operatively coupled. For example, information processor 102 may be in operable communication with one or more other server computers that host or store content in various databases.

In a preferred embodiment, information processor 102 and workstations 104, 106, 112 and 114 are any devices that are capable of sending and receiving data across communication network 108, e.g., mainframe computers, mini computers, personal computers, laptop computers, personal digital assistance (“PDA”), cellular telephones and Internet access devices, such as web TV. Further, information processor 102 and workstations 104, 106, 112 and 114 are preferably equipped with web browser software, such as MICROSOFT INTERNET EXPLORER, MOZILLA FIREFOX, GOOGLE CHROME or the like. Information processor 102 and workstations 104, 106, 112 and 114 are coupled to communication network 108 using any known data communications networking technology.

The various components information processor 102 need not be physically contained within the same chassis or even located in the single location. For example, storage devices may be located at a site, which is remote from the remaining elements of information processor 102, or may even be connected to a CPU across communication network via a network interface. Information processor 102 preferably includes sufficient memory and storage to provide forums in various community services as well as acting as a web server for communicating hypertext mark-up language (HTML) Java applets, Active-X control programs or the like to workstations 104, 106, 112 and 114. Information processor 102 is preferably arranged with components, for example, suitable for any expected operating environments and to ensure that capacities are arranged to accommodate expected demand.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL, PHP and a plurality of web site development applications.

Although the systems and methods are described by way of example herein and in terms of a web-based system using web browsers and a web site server (e.g., information processor 102), system 100 is not limited to such a configuration. It is contemplated that system 100 is arranged such that workstations 104, 106, 112 and 114 communicates with and displays data received from information processor 102 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 102 and workstations 104, 106, 112 and 114, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other similar known suitable operating system.

As used herein, references to displaying data on information processor 102 and workstations 104, 106, 112 and 114 regard the process of communicating data across communication network 108 and processing the data such that the data is viewed on a display, for example, by using a web browser and the like. As is known with web browsing software, the display on workstations 104, 106, 112 and 114 presents sites within the system 100 such that a user can proceed from site to site within the system by selecting a desired link.

Therefore, each user's experience with system 100 is based on the order with which he/she progresses through the display screens. Graphical screen controls are preferably available in the display screens and modules to initiate data processes, and to provide convenient navigation between the display screens and modules of system 100. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 100.

Although the hardware arrangement shown in system 100 illustrates a plurality of computing devices communicating over a communication network, the invention is not so limited. It is envisioned herein that traditional “brick and mortar” retail establishments will benefit greatly from the teachings herein. For example, and as will become apparent to one skilled in the art, use of the electronic functionality made available over the Internet is converted to physical media, such as to provide coupons and written material that registered consumers take with them to the registered vendors' brick and mortar stores.

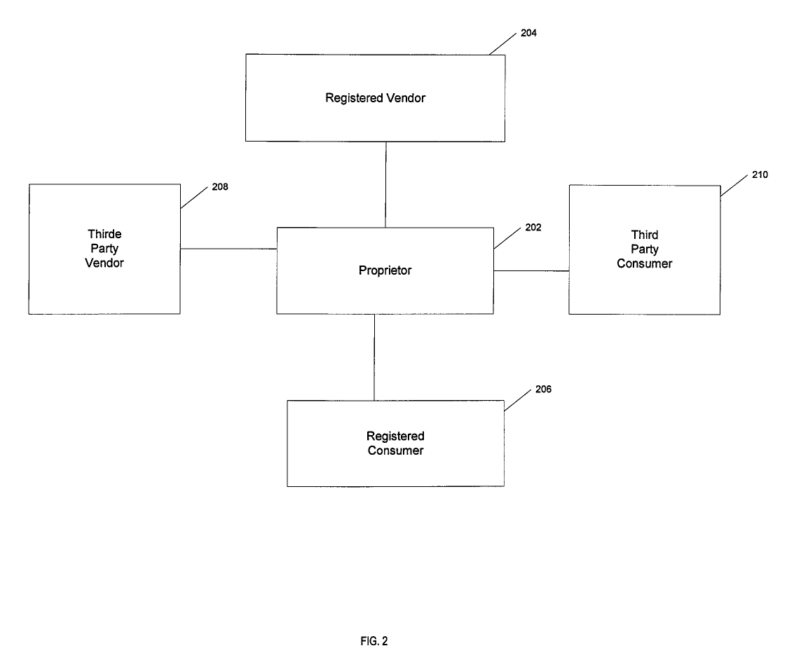

FIG. 2 illustrates an example layout of parties associated with the Internet Commerce Center in accordance with the teachings herein. As shown in FIG. 2, proprietor 202 of information processor 102 preferably controls or otherwise implements any combination of at least some of the features, systems and methods described herein. Registered vendors 204 and registered consumers 206 communicate with proprietor 202, such as via workstations 104 and 106 over communication network 108. Moreover, third party (or nonregistered) vendors 208, including vendors who wish to browse web pages and options provided on information processor 102, or vendors who wish to advertise on web sites provided by information processor 102, such as via banner advertisers or the like, are also supported. Also and as shown in FIG. 2, third party (or nonregistered) consumers preferably communicate with proprietor 202 via workstations 114 over communication network 108. Accordingly, and as shown in FIG. 2, a plurality of parties interact via communication network 108 in accordance with the teachings herein.

### Registered Vendors

In a preferred embodiment, information processor 102 provides an Internet web site to which registered vendor workstations 104 connect to provide information processor 102 with information regarding their respective stores, incentives, goods and services offered for sale by the respective registered vendors 204. Preferably, registered vendors 204 submit information to information processor 102 that is used to produce incentives and customized advertisements in connection with the stores or the goods and services offered for sale, etc. Incentives include coupons, sale advertisements, discount advertisements and information on particular items for sale. Further, a database of graphical icons and other material is preferably accessible by a registered vendor 204 to develop advertisements and/or one or more customized Internet web pages that are accessible by registered consumer workstations 106. In an alternative embodiment, a registered vendor 204 submits a request to the proprietor of information processor 102 for customized graphic development.

In addition to identifying information about registered vendors' 204 incentives, stores and/or goods or services offered for sale, registered vendors 204 preferably specify information regarding discount sales dates and times, as well as the particular demographic or target audience that a registered vendor 204 desires to be reach. In one embodiment, an automatic e-mail generation module is available for registered vendors 204 to submit information that defines e-mail recipients and/or information that the registered vendor 204 desires to have automatically e-mailed on regular and/or periodic bases. Registered consumers 206 preferably indicate to information processor 102 an acceptance or agreement to receive e-mail messages that are sent from registered vendors 204.

Accordingly and in a preferred embodiment, registered vendors 204 identify information for coupons that are generated by information processor 102. For example, registered vendor 204 submits information regarding an item that is offered at a discounted sales price, a data range when the item is offered at the discounted price, and any other information the registered vendor 204 deems suitable or that is supported by information processor 102. The information received from registered vendor 204 is preferably arranged to provide coupons, advertisements, or other types of exposure for registered vendors 204. In one alternative embodiment, information processor 102 identifies flyers, mailings or other printed material that is suitable for displaying information about the registered vendors 204, and forwards the information to the provider of the flyers, mailings or other distributions. This enables the registered vendor 204 to enjoy additional or extra exposure that would have otherwise been unavailable or less convenient. Thus, and as described above, registered vendors 204 are provided with access to respective web site areas on information processor 102 for uploading information that can be used, for example, to generate coupons.

In yet another alternative embodiment, information processor 102 uses the information submitted by the registered vendor 204 to generate customized banners, pop-up windows, FLASH advertisements or other Internet-related commercials that also serve to increase the registered vendors' 204 exposure to various markets. In one embodiment, FLASH advertisers freeze when the user places his mouse or other selection device over the advertisement. In a preferred embodiment, information processor 102 generates a bar code that includes information regarding an item offered for sale and/or at a discounted price, and the bar code is placed on a coupon generated by information processor 102. Further, information processor 102 preferably assigns each respective registered vendor user workstation 104 a unique identifier, which can be determined as a function of the bar code. The respective identifier assigned by information processor 102 for the registered vendor workstations 104 (or the registered vendors 204 themselves) may be generated in various and suitable ways. For example, the registered vendor workstation's 104 Internet protocol (“IP”) number, the registered vendor user work station's 104 MAC address, other preexisting unique identifier that is obtained by information processor 102 is used to generate an identifier to represent the respective registered vendor 204.

In an embodiment, an option is provided for a code that is generated for registered consumers 206. Information provided via this code enables identification of, for example, the registered consumer 206. In another embodiment, a code is generated that is the first two letters of the registered vendor's 204 name and the last two letters of the registered vendor's 204 name and that are combined with the registered vendor's 204 zip code. Alternatively, later, when registered consumers 206 redeem coupons generated in accordance with the teachings herein, the respective registered vendor 204 can easily determine the authenticity of the coupon by scanning the bar code. Thus, abuse of the system and fraudulent activity is reduced or eliminated in accordance with the teachings herein. The system generates a code (e.g., a bar code) for each member that enables tracking, such as for registered consumers 206 or registered vendor 204 via the printed coupon.

Moreover, and as noted above, registered vendors 204 can access respective web pages and display screens provided by information processor 102 in order to develop custom web pages that registered consumers 206 (or, alternatively, non-registered consumers 210) access to view information about the respective registered vendors 204 incentives and/or the particular goods and services offered for sale thereby. By selecting options made available by information processor 102 for developing registered vendor 204 web pages, a uniform and consistent appearance is provided for a plurality of registered vendors 204, thereby enabling a convenient and familiar interface for registered consumers 206 to peruse information regarding registered vendors 204 and their respective goods and services. Preferably, registered vendors 204 are provided access to a database of artwork, including graphic icons, wallpaper, banners or other content, for building attractive and professional appearing web pages. Registered vendors 204 preferably use interactive tools provided by information processor 102 to design the appearance of web pages, as well as to define particular goods and services for sale and respective incentives (including coupons) therefor. In one embodiment, vendors 204 are provided with tools to develop partial web pages, including a banner page or even a component that can is embeddable in a web page.

Although many of the examples and features described herein include Internet web pages, the invention is not so limited. As noted above, any on-line platform is supported, including for messaging devices (including SMS), such as smart telephone devices, PDA's or the like.

By providing interactive tools for registered vendors 204 to build web pages, and by hosting the web pages, a registered vendor 204 can enjoy increased web traffic and exposure and at a lower price than by hosting an individual web site that competes against large sites that enjoy a vast majority of web traffic, largely driven by popular search engines, such as GOOGLE and YAHOO!. Consumers using a search engine preferably locate a registered vendor's 204 page hosted on information processor 102, and, once connected, the consumer can discover coupons offered thereby, as well as other incentives offered by a plurality of other registered vendors 204. Accordingly, registered vendors 204 enjoy increased exposure in accordance with the teachings herein, thereby enabling increased sales while consumers enjoy savings and other incentives from offers made thereby. In one embodiment, keywords and other search terms entered by users in third party search engine web sites 110 are stored by information processor 102, for example, for search engine optimization, analysis and building metrics associated with particular users.

In addition to discounts offered with particular goods and/or services, discounts and/or coupons may be offered by registered vendors 204 based on a time or date of purchase. For example, a registered vendor 204 does not have much in-store traffic during the hours of 3:00 p.m.-5:00 p.m. In an effort to increase sales opportunities during those hours, the registered vendor 204 submits coupon information to information processor 102 that an extra 5% savings is available for registered consumers 206 (and non-registered consumers 210) who come into the store with coupons printed via information processor 102 during the hours of 3:00 p.m.-5:00 p.m.

In one embodiment, information processor 102 generates advertisements, including banner advertisements for registered vendors 204 and displays the advertisements to registered consumers 206 at various times and in various display screens, such as when registered consumer 206 is browsing another vendor's products, has previously searched for goods or services (including in a third party search engine 110), or other times defined by registered vendor 204. Preferably, banner advertisements are dynamically displayed, such as by adjusting their relative positions in a web page depending upon the position in a page where a user is viewing.

Other options provided by information processor 102 for registered vendors 204 include automatically updating coupons and printing fliers and other mailings. Preferably, various package offers are available for registered vendors 204, including a fixed number of printed mailings, a number of banner advertisements, a number of pushed e-mail messages, short messaging service (“SMS”) messages or the like. Moreover, weekly or monthly coupon books are preferably provided that are categorized and include incentives in an appropriate context. For example, a LEXUS car dealership will not have a coupon book that displays HONDA vehicles. The various packages represent the amount of exposure a registered vendor 204 is provided via information processor 102.

### Registered Consumers

In accordance with the teachings herein, consumers access information processor 102 in order to review and/or print information regarding registered vendors 204, and offers of goods and services for sale thereby. Consumers may peruse an online catalog or other display of coupons for goods and services offered by registered vendors 204, and may receive discounts or other benefits from registered vendors 204 that are redeemable upon physically presenting the coupon in a store.

As noted above with regard to exclusive and restricted access to web pages for registered vendor workstations 104, information processor 102 also preferably provides access to restricted web pages to consumers who register with information processor 102, thereby becoming registered consumers 206. Information submitted by consumers, for example, that represents demographics, economics, interests and past purchases is particularly valuable for vendors. Many consumers, however, are unlikely to volunteer such information without some form of remuneration or benefits. Accordingly and in one embodiment, consumers are rewarded for high quality and/or quantity of information that they submit to information processor 102 upon registration, or any time thereafter, such as during a sale or discounted sale offer. For example, a consumer who registers and elects to submit accurate information regarding his/her demographics, economics, interests, past purchases may receive a greater discount on goods or services offered by registered vendors 204 than a consumer who registers by merely submitting his/her name and e-mail address. Other benefits are similarly envisioned herein, such as reduced membership costs for registering with information processor 102, or expedited notification of a registered vendor's 204 sale.

Thus, in order to enjoy access to coupons and other incentives offered by registered vendors 204 via information processor 102, consumers register with information processor 102.

In one preferred embodiment, information processor 102 electronically identifies a user, such as via a cookie, as known in the art, generated or modified during the registration process. Alternatively, other authentication information may be used to identify a registered (or non-registered) consumer workstation 106, such as by examining a consumer's IP address, MAC address or other identifier to determine a consumer workstation 106. Preferably, incentives (e.g., coupons) for registered consumers 205 are provided with a bar code that reflect the member and each time the member downloads or prints a coupon the system add directly or indirectly (such as 001, 002, 003, or AB1 AB2 or in another hidden way). The code, such as provided in a bar code format enables tracking of the number of coupons the registered consumer 206 has printed, the identity of the consumer 206, when the coupon was provided and the ending number of the last coupon. This makes any coupon for any registered users available and useful for security against fraud or coupon theft, for example. Members can to use the information provided via information processor 102 to print coupons and then publish it in his website will mistakenly think that that code needs to apply for that coupon which really is for our information we will then discover that this website shows the same type of coupon that we are showing and by the code we will know exactly which client it is. There is always the possibility that someone would steal the information of a coupon that belongs to a member and publish it on a website. Moreover, coupons may be printed via a pop-up window that will be the source that will show the coupons that were selected by the member (such as paying a credit card online: the information appears in a different window). Additionally, information processor 102 may use the consumer workstation 106 identification to provide geographically relevant information.

In an embodiment registered consumers 206 have an option to save sales advertisements, discounts, coupons or the like for the future, saved and made available, in an option for a “Calendar of sales.” For example, registered consumers 206 preferably save coupon/incentive-related data to a calendar, such as provided in a personal information management software, such as MICROSOFT OUTLOOK, thereby enabling planning of savings in accordance with the teachings herein. For example, coupons, incentives or the like can be stored in the calendar of savings for future shopping, trips and events, such as birthdays. By integrating coupons and incentives with a calendar and events, coupons can be located and/or provided that comply with a particular context. For example, the Smith family goes on a trip to Orlando in July, and information processor 102 identifies coupons that relate to the word “travel” and “Orlando” and the related dates that the Smith are traveling. In this way, coupons are available in particular contexts, and at particular times.

Consumers 206 can also use the Calendar of Sales option (or other available option) to request vendors 204 to transmit information regarding future sales, future discounts and incentives, future clearances or the like. In this way, consumers 206 maintain current and up-to-date information on the many benefits provided by registered vendors 204.

Further, the Calendar of Sales provides an alternative to transferring messages between registered consumers 206, for example, regarding sales advertisements, coupons or the like. Further various messaging options, such as known in the art, are preferably supported in the Calendar of Sales. Calendar of Sales is useful for future savings planning, such as weekly, monthly or even annually.

In an embodiment, the Calendar of Sales option facilitates messages to be sent between registered consumers 206, for example, to alert consumers 206 that another member is looking to save (or is already saving) via a specific discount (in his Calendar of Savings) to use in the future, and when available, the receiving consumer 206 can benefit therefrom. In case consumer 206 cannot use the discount in the future, a message is transmitted identifying a restriction or the like on the discount (coupon) and that the discount can only be used in a certain period of time. In an alternative, the system waits for a response from a registered consumer and, thereafter, confirms, approves or limits the time spent on this discount, and then highlights the coupon's space in the Calendar of Sales for the registered consumer. If the registered consumer fails to respond on time (e.g., 2 days after the submission), a message is sent to both of them indicating that the request is not going to be fulfilled. The requests can be for various options, such as more time to use a coupon, use of the coupon for more then one product, increased percentage savings, apply the coupon to different products, free or discounted shipping, or the like.

Preferably, a system is provided that attracts clients for service providing businesses or offices that do not otherwise produce or provide coupons, referred to herein as a “service business client.” A service business client may purchase coupons for other businesses (such as for brand named products from GAP, BED BATH AND BEYOND, TARGET, etc.), while promoting themselves on the web site provided via information processor 102. In this way, service business clients offer their services with a coupon of the brand name that they bought to provide to their clients. Accordingly, service business clients will offer their clients coupons or other incentives worth some amount for brand name products, such as sold at the GAP. This way they will attract clients for their services and the proprietor of information processor 102 provides both parties with improved service.

In another embodiment, a feature referred to herein as a “Garage Sale Locator” is provided. This feature provides a map of garage sales that are taking place locally in the user's area including the essence of the garage sale (e.g., what is being sold, including photos and prices thereof).

In another embodiment, the systems and methods herein can be used for a direct/e-mail marketing campaign by registered vendors 204. For example, registration information submitted by registered consumers 206, registered vendors can identify particular consumers 206 who are located within specific geographic areas, have expressed interest in particular goods or services or are part of a particular demographic (age, gender or the like). The vendors 204 can target those individuals and send notifications regarding coupons, sales, clearances or the like.

In another embodiment, a database for a plurality of banners that are designed for various industries, such as automobile, clothing, restaurants, etc. The banner may be provided via a web log (“blog”) or, when selected, leads a consumer 206 to a blog that identifies incentives for a respective vendor 204. Moreover, vendors 204 can identify respective times and dates for publishing banners and/or respective blogs for consumers 204. Accordingly, a pre-programmed tool is provided to allow registered vendors 204 to select the type of area/demographic/age or the like that the vendor wants to reach and the different times/dates/etc., and to publish it all in a click of a button. Moreover, a database of many differently designed e-mail messages for various industries, such as automobile, clothing, or restaurants, that lead to a blog or other on-line resource that includes information that the registered vendor 204 wants to have. For example, the registered vendor 204 selects an e-mail design from a database, and selects when the e-mail should be published according to a publish system schedule. Further, a registered vendor 204 can use the systems and methods described herein for messaging, such as via SMS, and can send SMS messages to consumers 206 upon request. The SMS text is selected by the vendor 204 from a SMS designated database. This service may be available, for example, for use on a mobile telephone where the vendor 204 can browse from different SMS texts and then send SMS messages to users whom the vendor 204 wants to target, such as for a specific promotion.

Once a SMS text message is selected for messaging and sent to a particular geographic location (e.g., a zip code), the same SMS message is preferably blocked for use in the same zip code and an administrator is notified to generate/provide new SMS content. In this way, consumers 206 are prevented from receiving the same designated SMS message. Once a vendor 204 selects a respective design, the selected design appears in the vendor's advertisements and other materials, such as promotional materials, web site displays or the like. Further, the vendor's 204 selected design is preferably reserved for that vendor, thereby precluding other vendors 204 from using the same design. In an embodiment, selected designs for SMS, banner advertisements, e-mail correspondence, sales advertisements or the like are stored in a database accessible by information processor 102, and useable by the respective vendor 204.

In yet another embodiment, a sales tax savings option is provided that directs users to registered vendors 204 who sell goods and/or services across state lines to avoid having incur sales tax for the consumer 206. For example, the consumer 206 identifies a vendor 204 that sells a particular item, such as a camera. The system automatically refers the consumer 206 to a different vendor 204 who is selling the same camera, but does not otherwise operate in the same state as the consumer 206 is located. In this way, no sales tax is incurred by the consumer 206 for purchasing the camera. Using the consumer 206 demographic information and the vendor 204 information, consumers can be directed out of state for sales tax savings. Also, if two vendors from different states have the same price for a specific product, the system automatically sends the consumer 206 to the vendor 204 that is closest to him geographically, to reduce shipping costs. For example, a consumer 206 from New York who is looking to purchase an MP3 player receives results from New Jersey and California at the same price, and the system automatically directs the consumer 206 to the New Jersey vendor.

In a preferred embodiment, a registered consumer workstation 106 connects to a web site provided by information processor 102 and is provided with various options for identifying particular registered vendors 204 and/or items offered for sale. Registered consumers 206 preferably access information processor 102 and view a list of, conduct search for, or otherwise locate a registered vendor 204 or category of registered vendors 204 to locate an incentive such as a coupon for a good or service that the registered consumer 206 is interested in purchasing.

Alternatively, a registered consumer 206 peruses a list or enters search criteria to identify a particular good or service that the registered consumer 206 is interested in purchasing. In this alternative, one or more items may be graphically displayed by respective registered vendors 204 who are offering the good or service for sale. Once the registered consumer 206 is informed of a particular registered vendor 204 who may be offering the good or service the registered consumer 206 is interested in for sale, a selectable control, such as a graphical screen icon or other hyperlink is provided for the registered consumer 206 to view a web page directed to the registered vendor 204. In one embodiment, the web page that is displayed is one that is provided by information processor 102 as defined or otherwise set up by a registered vendor 204, as described above. Alternatively, the selectable connection links the registered consumer 206 to an independent web site of the registered vendor 204. Once the registered consumer 206 identifies a respective registered vendor 204 who is offering a good or service that the registered consumer 206 is interested in, an incentive, such as formatted as a coupon, is preferably made available for the registered consumer 206 to purchase the good or service at a reduced price.

As noted above, in order to become a registered consumer 206, a user submits information about him or herself to information processor 102. For example, the user submits information regarding his or her name, residence, age, profession, affiliations, interests, or any other information a registered vendor 204 may want and that is deemed suitable by a proprietor of information processor 102. Moreover, the user may be required to make a payment to complete the registration process. In one embodiment, new users are invited to enjoy a trial registration membership period in which the user can enjoy at least some of the benefits of the teachings herein. For example, a new user registered on a trial basis uses the web site hosted by information processor 102 and purchases goods and services for a limited period of time for a limited number of instances from one or more registered vendors 204 at a reduced price. Thus, in one embodiment, a trial registration provides consumers with fewer benefits than a paid-for or full registration. For example, a consumer is entitled to a limited number of coupons, such as three coupons, during a trial period. After the trial membership period runs out, or the number of trial instances are used, then the consumer is preferably prompted to complete a full registration process to become a “registered consumer 206.” In a preferred embodiment, registered consumers 206 pay an inexpensive fee to the proprietor of information processor 102 in order to enjoy the benefits of the teachings herein. For example, registered users are charged five dollars a month to maintain a current membership. Of course, one skilled in the art will recognize that any monthly fee or other periodic fee can be charged for membership.

In addition to providing registered consumers 206 with access to incentives, including coupons, for discounted prices of goods and services for sale by registered vendors 204, information processor 102 preferably hosts one or more web pages for registered consumers 206 to interact in various ways. In one embodiment, additional benefits or incentives associated with purchasing goods and/or services in volume are available to registered consumers 206 who band together to purchase in volume. Information processor 102 preferably enables users to locate and communicate with other users who are or may be interested in purchasing similar or the same goods or services. Registered vendors 204 may be willing to discount the price of goods or services further with the prospect of a guaranteed minimum number of sales. Accordingly, information processor 102 enables registered consumers 206 to locate and band together with other registered consumers 206 in various ways to purchase goods or services in volume.

In one embodiment, information processor 102 provides a web page is provided for registered consumers 206 to post messages seeking other registered consumers 206 to purchase a good or service. Referring herein, generally, as “Team and Buy,” registered vendors 204 may offer goods or services at further discounted prices when a minimum number of sales are assured. Alternatively, a number of registered consumers 206 who commit to purchase a good or service from a registered vendor 204 may make an offer to the vendor to purchase the good or service at a proposed discounted price.

For example, a registered consumer 206, Tom, posts a message on information processor 1102 that he is looking to purchase a surround sound entertainment system. Noting that the entertainment system has a 10% discount coupon associated with it by a registered vendor 204, Tom posts a message seeking nine additional registered consumers 206 who are interested in the same entertainment system. Nine other registered consumers 206 reply to Tom, including by posting messages to each other, and commit to purchasing the entertainment system. Once Tom and the nine other registered consumers 206 have banded together to purchase ten entertainment systems, at least one of various options is available to them. One option is that the registered vendor 204 is approached and requested to reduce the price of the entertainment system due to the volume sales purchase. Information processor 102 may contact the vendor electronically or, alternatively, one or more of the registered consumers 206 may contact the vendor directly. In one embodiment, the registered consumers 206 band together and the registered vendor 204 is contacted, thereafter. Alternatively, the registered vendor 204 independently posts a notice that a coupon or further reduction is available for volume purchases.

Thus and in accordance with a preferred embodiment, a social network feature is provided such that registered consumers 206 can converse and band together in an effort to enjoy further discounts and savings from registered vendors 204. Other social activity is preferably supported, including for sharing comments, and multimedia content.

In one embodiment, registered consumers 206 pay a periodic, e.g., monthly, fee to the proprietor of information processor 102 for access to registered vendors 204 and the various discount and coupon offers provided thereby. It is recognized that some consumers who use the Internet do not wish to pay anything for on-line related services, and may be averse to paying periodic fees for use of the teachings herein. Accordingly, in one embodiment, consumers are provided trial membership for a period of time, which enables the consumers to enjoy and recognize the benefits of the teachings herein, including access to web pages for registered vendors 204 and savings from coupons and other incentives provided thereon.

### Benefits

In addition to providing discounts and coupons for registered (and non-registered) consumers, and for selling goods and services associated with coupons, valuable information can be determined and provided by information processor 102 for the benefit of registered vendors 204. As described above, during the registration process and at various times thereafter, information processor receives demographic, personal, economic, purchasing and other information from registered consumers 206. Each time a coupon is printed by a registered (or non-registered) consumer, information processor tracks the consumer (or alternatively some other identifier, such as the registered consumer workstation's 106 IP address, MAC address or the like) who accessed and/or printed the coupon. In a preferred embodiment, printing coupons is executed by selecting options provided by information processor 102 instead of independent web browser options, such as selecting File, Print from a menu or selecting a graphical icon for printing. Preferably, a code or other indicia is provided by information processor 102 whenever a coupon is printed by proper user selections. In case a user elects to merely print a coupon, such as by selecting a web browser Print icon, the necessary indicia will not be printed and registered vendors 204 will be notified that the registered consumer did not follow proper procedure, thereby invalidating the coupon. By controlling printing operations in this, better tracking mechanisms are ensured and a possibility of fraud is reduced.

The data obtained by information processor 102, for example, during the registration process and at the time the registered consumer 206 prints a coupon, enable information processor 102 to generate metrics for registered vendors 204 that provide insights for vendors to determine where consumers are located, what they are looking at, their age, their socio-economic demographics, their purchasing interests or the like, for example to improve marketing and increase sales, and improve profitability. For example, registered vendors 204 are informed of the number of “clicks” there were on a certain advertisement, how many people viewed an advertisement over a set period of time, demographic information of people who viewed/selected an advertisement, the kinds of goods/services sold or offered in respective advertisements or the like.

In one embodiment, when a coupon is redeemed by the registered consumer 206 at the registered vendor's 204 retail establishment, the vendor preferably scans a bar code that is printed on the coupon, or fills in his register cashier his coupon number or writes down the coupon number on a note or in any other way and may or may not send the information in the note from time to time to information processor 102. The bar code may embed information desired by the registered vendor 204, including, for example, the identity of the consumer, the time of day that the coupon was printed, the good or service to which the coupon pertains, or the like. In one embodiment, the registered vendor 204 uploads information from the coupon to information processor 102, which enables information processor 102 to identify whether and when a transaction related to a coupon or other incentive was completed. Registered vendors 204 are preferably offered an incentive to upload information from the coupon to information processor 102, such as a reduction in monthly fees, a reduction in the percentage owed in connection with a sale or some other incentive offered by the proprietor of information processor 102. By obtaining information representing completed transactions, additional metrics may be calculated and provided for prospective registered vendors 204 and/or prospective registered consumers 206 to indicate the benefits of the teachings herein.

In one embodiment, information processor 102 ensures that offers and incentives offered by registered vendors 104 are made equally available for consumers, thereby ensuring relatively equal exposure for a plurality of vendors. For example, a registered consumer 206 searches for incentives (e.g., coupons) from registered vendors 204. A number of screen displays (e.g., pages) of incentives are provided by information processor 102, and the registered consumer 206 scrolls through the pages. It is recognized that users often do not scroll through many pages of search results, and that if a search result is not presented in the first page of search results, the user will never see the results. In an effort to provide equal exposure of incentive offerings to users, information processor 102 preferably selects the first listed incentive on each of the pages and displays a list thereof. Referred to herein, generally as “jump first,” the first incentives listed on, for example, pages 20, 19, 18, 17, 16 and 15 are selected and displayed on the first page. Information processor 102 further rotates the ordering so that different entries receive equal attention from consumers.

By maintaining a centralized process and source for generating incentives, including coupons, for consumers, the teachings herein prevent instances of fraud or other dishonest activity. As noted above, as desktop publishing techniques have improved and become more available to consumers, a likelihood of fraud, including generating fake coupons or other incentives that appear very authentic increases. By providing bar coded and other secure data on coupons provided by information processor 102, the likelihood of such fraud is reduced dramatically, if not completely eliminated. Thus, registered vendors 204 can rest assured that coupons or other incentives redeemed at their stores are authentic.

### Implementation

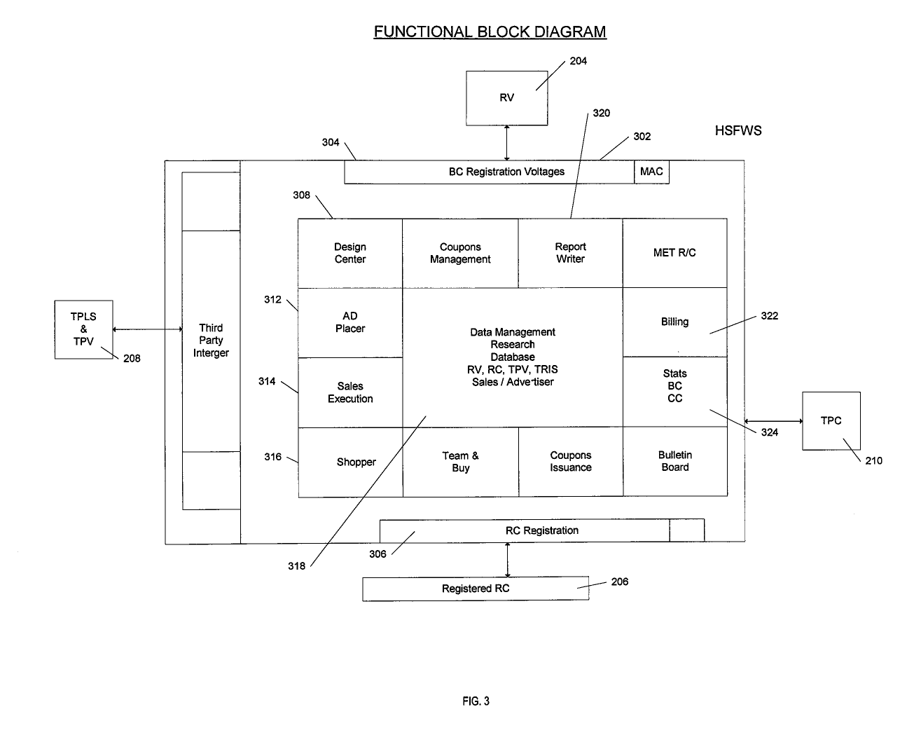

FIG. 3 illustrates an example site map 202 that represents a series of web pages and/or functionality provided by information processor 102 in a preferred embodiment. As described above, registered vendor workstation 104 and registered consumer workstation 106 access information processor 102 over communication network 108. Once connected, information processor 102 preferably provides display screens that include graphical screen controls for users to make selections, enter information and avail themselves of the features according to the teachings herein. For example, registered vendor workstations 104, registered consumer workstations 106, third-party vendor workstations 112, third party consumer workstations 114 access information and display screen on information processor 102.

Continuing with reference to FIG. 3, vendor registration module 304 and consumer registration module 306 provide data entry controls that enable vendors and consumers to reply to prompts and submit information to register with proprietor 202, as described above. In one embodiment, registered vendors 204 and/or registered consumers 206 tender payment by submitting credit card, PAYPAL or other payment information to information processor 102 to register or otherwise access areas of information processor 102 that are restricted to registered users. For example, registered vendor workstations 104 access design center 308 to build one or more custom web pages. As noted above, information processor 102 receives vendor-related information, including for goods and services, and coupons or other incentives therefor in coupon management module 310 and generates custom web pages for registered vendors 204 incorporating the received information. Information processor 102 further receives selections of graphic options and/or various artwork from vendors 204 that are also used by information processor to build custom web pages for registered vendors 204.

The graphic options and/or the various artwork may be supplied by artists, graphic designers or the like for information processor 102. In an embodiment, once a vendor 204 selects a respective graphic option and/or artwork, the selected graphic option and/or artwork is not made available for another vendor 204. In an alternative embodiment, multiple vendors 204 can select the same graphic options and/or artwork provided the vendors are not competing with each other in a geographic region. In this alternative embodiment, for example, two vendors 204 who sell shoes may have the same artwork on their respective web pages provided they are not physically located in the same area. In yet another alternative embodiment, no two vendors 204 who are in the same business are permitted to share the same artwork and/or graphic selections. In this embodiment, consumers 206 would not be confused with the same artwork and/or graphic selections shown on the web sites of two vendors in the same business.

Continuing with reference to FIG. 3, advertisement placement module 312 is provided for proprietor 202 of information processor 102 to promote third party vendor (or registered vendor 204) advertising to generate revenue. For example, information processor 102 charges a fee to display banner advertisements, as known in the art, Alternatively or in addition, a fee is charged to vendors each time a user selects or “clicks” on a banner advertisement. In one embodiment, banner advertisements displayed by information processor 102 are for the same or similar goods or services that a respective consumer is searching for or viewing.

Sales execution module 314 may be provided to enable a sale of a good or service from a registered vendor 204 to a consumer. In one embodiment, sales execution module 312 simply provides a link or other connection to a registered vendor's 204 web page and any sale of goods and/or services is completed without substantial or any further assistance or input from information processor 102. Shopping module 316, similarly, may be provided to enable registered consumers 206 to locate goods and services offered for sale by registered vendors 204.

As noted above, a benefit of the teachings herein regards the amount and kinds of data that information processor 102 is receives in connection with registering vendors and consumers, selections and printing of coupons, web site traffic, redeemed coupons and other information representing user activity in connection with information processor 102. Data management module 318 preferably provides database storage of data regarding registered vendors 204, registered consumers 206, third party vendors, advertisers, sales information, coupon information or the like. Such information is preferably available for research and other benefits of registered vendors 204, registered consumers 206 or third party advertisers.

Continuing with reference to the example site map shown in FIG. 3, report writer 320 prepares and outputs reports based on information and data stored in data management module 318. Billing module 322 preferably generates and/or sends invoices to registered vendors 204 and/or registered consumers 206. Further metrics/statistics module 324 uses information stored in data management module 318 to derive metrics and statistics regarding registered consumers 206, particularly with regard to the use and benefits of information processor 102. For example, registered consumer 206 demographic information is compiled and registered consumers are tracked as they access web sites provided by information processor 102, including when registered vendors' 204 web pages are accessed and when coupons or other incentives are accessed by registered consumers 206.

Further, by reviewing statistics, potential shortcomings are identified for improvement. Areas of particular focus may be identified for the future. Moreover, areas of success and strength are preferably identified, as well. Further, vendors 204 are preferably notified of various offers, including for the sale of banners, e-mail campaigns, coupon book upgrades, search engine options and other promotions.

Although the present invention has been described in relation to particular embodiments thereof, many other variations and modifications and other uses will become apparent to those skilled in the art.

For example, many of the descriptions and examples herein refer to discounted prices for goods and services, such as a function of redeemable coupons, alternative benefits for using systems and methods is provided herein are envisioned. In one alternative embodiment, hard to get items or specialty items are offered and available for sale or rent. Such goods or services may be extremely difficult or impossible to obtain without use of the systems and methods provided herein. Moreover, many of the examples set forth herein regard traditional brick and mortar retail stores, where registered consumers 206 hand over their coupons for redemption. In alternative embodiments, the teachings herein are suitable for entirely electronic commerce applications. For example, registered users receive electronic coupons, personal codes, or other information that is usable to redeem at a registered vendor's 204 e-commerce web site. At the time of purchase, for example, the registered user submits the electronic coupon. Preferably, information pertaining to the transaction is stored in a database managed by information processor 102, and used for reporting, statistical analysis and generation of metrics, substantially as described above.

It is preferred, therefore, that the present invention not be limited by the specific disclosure herein.

What is claimed is:

1. An electronic commerce center, the center including:
at least one processor operatively coupled to one or more processor readable media and a communication port;
a database accessible by the at least one processor and stored on the at least one or more processor readable media, the database comprising:
electronic vendor information that represents vendors of one or more of goods and services;
electronic goods and services information that represents at least one of goods and services offered for sale by the vendors; and
electronic consumer information that represents consumers of goods and services; and
an Internet web site provided by the at least one processor that includes electronic tools for the vendors to build custom web pages to be included in the Internet web site, and that further includes interactive options for the consumers to communicate with each other;
wherein the processor uses the electronic goods and services information to generate electronic incentive information that represents incentives offered by the vendors, wherein the incentives relate to the at least one of goods and services offered for sale by the vendors.

2. The electronic commerce center of claim 1, wherein the incentives are coupons that are redeemable at the physical location where the vendors sell the at least one of goods and services.

3. The electronic commerce center of claim 1, wherein the internet web site further receives an offer from a plurality of consumers for the purchase of the at least one of goods and services from one of the vendors at a reduced price.

4. The electronic commerce center of claim 1, wherein the electronic goods and services information further represents an offer from at least one of the vendors to sell the at least one of goods and services at reduced price if a plurality of consumers purchase the at least one of goods and services.

5. The electronic commerce center of claim 1, wherein the internet web site further includes a vendor registration module and a consumer registration module.

6. The electronic commerce center of claim 5, wherein the vendor registration module receives electronic information in response to a prompt from the processor that represents a particular consumer demographic that one of the vendors targets for sale of the at least one of goods and services, and the processor assigns a unique identifier for the one of the vendors.

7. The electronic commerce center of claim 5, wherein the consumer registration module receives electronic information in response to a prompt from the processor that represents a particular demographic of one of the consumers, and the processor assigns a unique identifier for the one of the consumers.

8. The electronic commerce center of claim 1, wherein the electronic goods and services information further represents a date or time when at least one of goods and services are offered at a discounted price.

9. The electronic commerce center of claim 1, wherein the internet web site further includes an print incentive module that generates a customized incentive for at least one of the at least one of goods and services sold by one of the vendors and outputs the customized incentive for one consumer to a printer.

10. The electronic commerce center of claim 9, wherein the processor receives electronic purchase information from one of the vendors when the at least one of the one or more of goods and services is sold and the customized incentive is redeemed, wherein the electronic purchase information is received in response to a prompt by the processor.

11. The electronic commerce center of claim 1, wherein the processor provides banner advertisements of at least one of the vendors and the at least one of goods and services to the consumers.

12. A method for providing an electronic commerce center, the method comprising:
providing at least one processor operatively coupled to one or more processor readable media and a communication port;
providing a database that is accessible by the at least one processor on the at least one or more processor readable media, the database storing:
electronic vendor information that represents vendors of one or more of goods and services;
electronic goods and services information that represents at least one of goods and services offered for sale by the vendors; and
electronic consumer information that represents consumers of goods and services; and
providing an Internet web site by the at least one processor that includes electronic tools for the vendors to build custom web pages to be included in the Internet web site, and that further includes interactive options for the consumers to communicate with each other;
generating electronic incentive information by the processor from the electronic goods and services information, wherein the electronic incentive information represents incentives offered by the vendors, wherein the incentives relate to the at least one of goods and services offered for sale by the vendors.

13. The method of claim 12, wherein the incentives are coupons that are redeemable at the physical location where the vendors sell the at least one of goods and services.

14. The method of claim 12, wherein the internet web site further receives an offer from a plurality of consumers for the purchase of the at least one of goods and services from one of the vendors at a reduced price.

15. The method of claim 12, wherein the electronic goods and services information further represents at least one of the vendors offer to sell the at least one of goods and services at reduced price if a plurality of consumers purchase the at least one of goods and services.

16. The method of claim 18, further comprising receiving by a vendor registration module electronic information in response to a prompt from the processor that represents a particular consumer demographic that one of the vendors targets for sale of the at least one of goods and services, and assigning by the processor a unique identifier for the one of the vendors.

17. The method of claim 16, further comprising receiving by a consumer registration module electronic information in response to a prompt from the processor that represents a particular demographic of one of the consumers, and assigning by the processor a unique identifier for the one of the consumers.

18. The method of claim 12, further comprising tracking the printing of a customized incentive for at least one of the at least one of goods and services sold by one of the vendors.

19. The method of claim 12, further comprising receiving electronic purchase information from one of the vendors when the at least one of the one or more of goods and services is sold and the customized incentive is redeemed, wherein the electronic purchase information is received in response to a prompt by the processor.

20. A system for vendors and consumers to sell and buy goods and services; the system comprising:
a web site linked to the internet being adapted to provide electronic tools for vendors of at least one of goods and services to build custom web pages, and to provide interactive options for consumers of the at least one of goods and services to communicate with each other;
a processor operatively coupled to the web site; and
one or more databases linked to the processor, the one or more databases containing data related to:
electronic vendor information that represents vendors of one or more of goods and services;
electronic goods and services information that represents at least one of goods and services offered for sale by the vendors; and
electronic consumer information that represents consumers of goods and services
wherein the processor uses the electronic goods and services information to generate electronic incentive information that represents incentives offered by the vendors, wherein the incentives relate to the at least one of goods and services offered for sale by the vendors.
